(19) United States
(12) Patent Application Publication
(10) Pub. No.: US 2024/0123871 A1
(43) Pub. Date: Apr. 18, 2024

(54) Vehicle Seat Adjustment System with Power Long Rails

(71) Applicant: Fisher & Company, Incorporated, St. Clair Shores, MI (US)

(72) Inventors: Mircea NAPAU, Sterling Heights, MI (US); Ileana Dacia NAPAU, Cugir (RO); Ioan NAPAU, Rochester Hills, MI (US); Sapan Mahendra POPTANI, Northville, MI (US); Ryan MARTIN, Macomb, MI (US)

(73) Assignee: Fisher & Company, Incorporated, St. Clair Shores, MI (US)

(21) Appl. No.: 18/377,894

(22) Filed: Oct. 9, 2023

Related U.S. Application Data
(60) Provisional application No. 63/444,667, filed on Feb. 10, 2023.
(60) Provisional application No. 63/415,470, filed on Oct. 12, 2022.

(51) Int. Cl. B60N 2/06; B60N 2/02; B60N 2/07

(52) U.S. Cl. CPC B60N 2/067; B60N 2/02253; B60N 2/0702

(57) ABSTRACT

A power rail system for a vehicle seat includes an outer track defining an elongated channel with an elongated lead screw mounted in the channel. An inner track is received in the elongated channel and a power length adjuster gear transmission is mounted to the inner track and drivingly engaged with the elongated lead screw. A seat structure is mounted to the inner track for movement along the power rail system.

### CROSS-REFERENCE TO RELATED APPLICATIONS

This application claims the benefit of U.S. Provisional Application No. 63/444,667, filed on Feb. 10, 2023 and U.S. Provisional Application No. 63/415,470, filed on Oct. 12, 2022. The entire disclosures of each of the above applications are incorporated herein by reference.

### FIELD

The present disclosure relates to a vehicle seat adjustment system with power long rails.

### BACKGROUND

This section provides background information related to the present disclosure which is not necessarily prior art.

This disclosure is related to a vehicle seat adjustment system (i.e., for adjusting the fore-aft position of a vehicle seat within a vehicle).

### SUMMARY

This section provides a general summary of the disclosure and is not a comprehensive disclosure of its full scope or all of its features.

According to an aspect of the present disclosure, a power rail system for a vehicle seat includes an outer track defining an elongated channel with an elongated lead screw mounted in the channel. An inner track is received in the elongated channel and a power length adjuster gear transmission is mounted to the inner track and drivingly engaged with the elongated lead screw.

According to another aspect, the inner track is supported within the channel by a roller bearing system.

According to another aspect, the roller bearing system includes front and rear roller cage pairs disposed at a front and a rear end of the inner track, respectively.

According to another aspect, the inner track includes a pair of side flanges and the front and rear roller cage pairs are supported by the side flange of the inner track.

According to another aspect, the front and rear roller cage pairs are clipped to the side flange of the inner track.

According to another aspect, the outer track includes a base and a pair of sidewalls, the pair of sidewalls each include a hook-shaped upper flange in cross-section.

According to another aspect, the inner track includes a pair of side flanges that are received in the hook-shaped upper flanges of the pair of sidewalls.

According to another aspect, the base of the outer track includes a pair of stepped side surfaces.

According to another aspect, the inner track is supported on the pair of stepped side surfaces by a roller bearing system.

According to another aspect, a pair of elongated carpet cover rails are connected on opposite sides of the outer track.

According to another aspect, the pair of elongated carpet cover rails are secured to the track by a plurality of carpet cover brackets.

According to another aspect, the inner track includes an upper wall and a pair of sidewalls and the power length adjuster gear transmission is mounted between the pair of sidewalls of the inner track.

According to another aspect, the power length adjuster gear transmission includes an input worm gear connected to a drive motor and an output worm nut disposed on the elongated lead screw and drivingly engaged with the input worm gear.

According to another aspect, the drive motor is a planetary gear motor.

According to another aspect, the power length adjuster gear transmission includes an input helical gear connected to a drive motor and an output helical gear nut disposed on the elongated lead screw and drivingly engaged with the input helical gear.

According to another aspect, the power length adjuster gear transmission includes a herringbone input worm gear connected to a drive motor and an output herringbone worm nut disposed on the elongated lead screw and drivingly engaged with the herringbone input worm gear.

According to another aspect, the elongated lead screw is mounted to a front attachment bracket and a rear attachment bracket each mounted to a base of the track.

According to a further aspect, a vehicle seat includes a pair of power rails each including: an outer track defining an elongated channel and an elongated lead screw mounted in the channel. An inner track is received in the elongated channel and a power length adjuster gear transmission is mounted to the inner track and drivingly engaged with the elongated lead screw. A seat structure is mounted to the inner track of each of the pair of power rails.

According to another aspect, a power rail system for a vehicle seat, includes an outer track defining an elongated channel with a pair of sidewalls each including an integrally formed screw thread rack. An inner track is received in the elongated channel and a power length adjuster gear transmission is mounted to the inner track and drivingly engaged with the screw thread racks on each of the pair of sidewalls.

According to another aspect, the power length adjuster gear transmission includes an input worm gear connected to a drive motor and a pair of twin drive worms drivingly engaged with the input worm gear and a respective one of the screw thread racks of the pair of sidewalls of the outer track.

According to another aspect, the inner track includes a first bent plate layered with a second bent plate, wherein the first bent plate defines a first of the pair of side flanges and the second bent plate defines a second of the pair of side flanges.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a pair of power long rail assemblies for a vehicle seat adjustment system according to the principles of the present disclosure;

FIG. 2 is an exploded perspective view of a power long rail assembly according to the principles of the present disclosure;

FIG. 3 is a top plan view of the pair of power long rail assemblies according to the principles of the present disclosure;

FIG. 4 is an end plan view of the inboard power long rail assembly;

FIG. 5 is a transverse cross-sectional view of the inboard power long rail assembly;

FIG. 6 is a perspective view of a vehicle seat power length adjuster transmission with parallel dual worm gear system according to an example embodiment;

FIG. 7 is an exploded perspective view of a parallel dual worm gear transmission according to the principles of the present disclosure;

FIG. 8 is a perspective view of a parallel dual worm gear transmission according to the principles of the present disclosure;

FIG. 9 is a top plan view of a self-locking parallel dual worm gear system according to the principles of the present disclosure;

FIG. 10 is an exploded perspective view of a parallel helical gear transmission according to a further example embodiment;

FIG. 11 is a top plan view of a parallel helical gear system according to the principles of the present disclosure;

FIG. 12 is an exploded perspective view of a herringbone type dual worm gear transmission according to a further example embodiment;

FIG. 13 is a top plan view of a herringbone type dual worm gear system according to the principles of the present disclosure;

FIG. 14 is a cross-sectional view of a lead screw front attachment system according to the principles of the present disclosure;

FIG. 15 is a cross-sectional view of a lead screw rear attachment system according to the principles of the present disclosure;

FIG. 16 is a perspective view of a pair of power long rail assemblies for a vehicle seat adjustment system according to a further embodiment of the present disclosure;

FIG. 17 is an exploded perspective view of the power long rail assembly shown in FIG. 16;

FIG. 18 is a top plan view of the pair of power long rail assemblies shown in FIG. 16;

FIG. 19 is an end plan view of the inboard power long rail assembly of FIG. 16;

FIG. 20 is a transverse cross-sectional view of the inboard power long rail assembly of FIG. 16;

FIG. 21 is a partial cutaway perspective view of the vehicle seat power length adjuster transmission of FIG. 16;

FIG. 22 is an exploded perspective view of a twin worm gear transmission according to the principles of the present disclosure;

FIG. 23 is a perspective view of the twin worm gear transmission according to the principles of the present disclosure;

FIG. 24 is a top plan view of a twin worm gear system according to the principles of the present disclosure; and

FIG. 25 is a top cut-away view of the twin worm gear system engaged with a twin-screw thread rack according to the principles of the present disclosure.

Corresponding reference numerals indicate corresponding parts throughout the several views of the drawings.

### DETAILED DESCRIPTION

Example embodiments will now be described more fully with reference to the accompanying drawings.

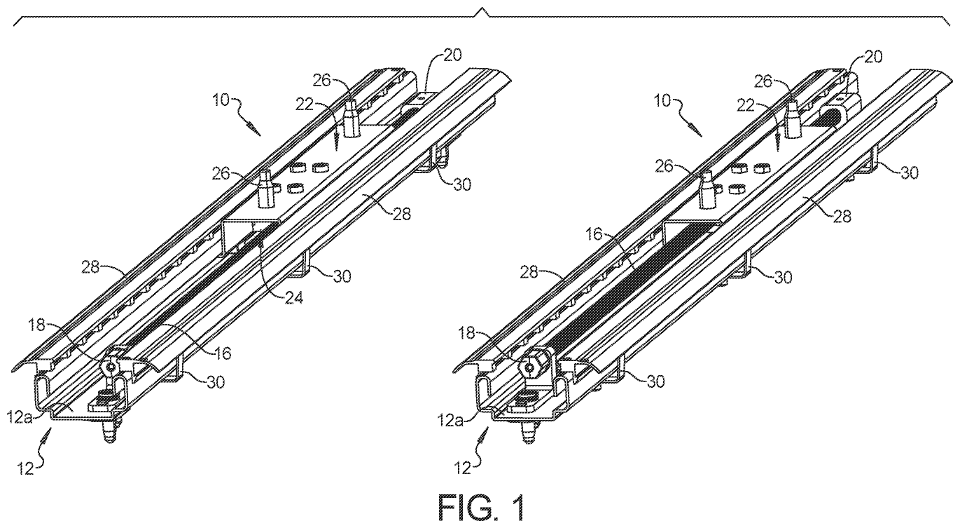

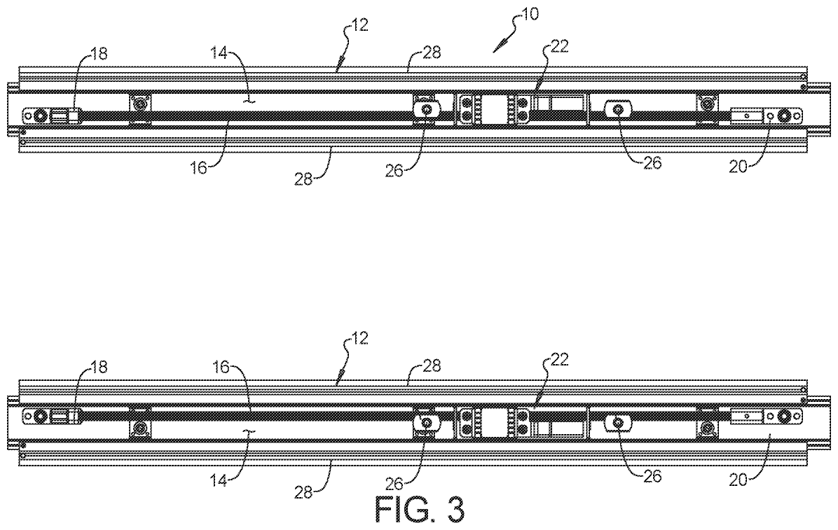

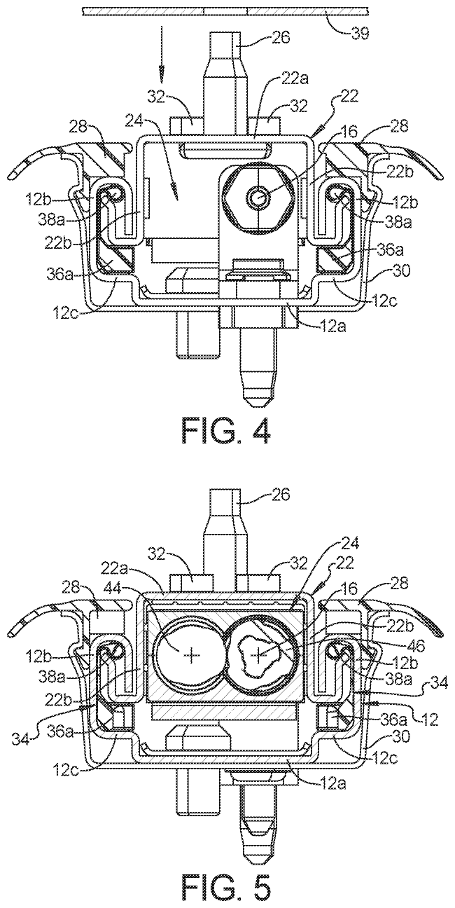

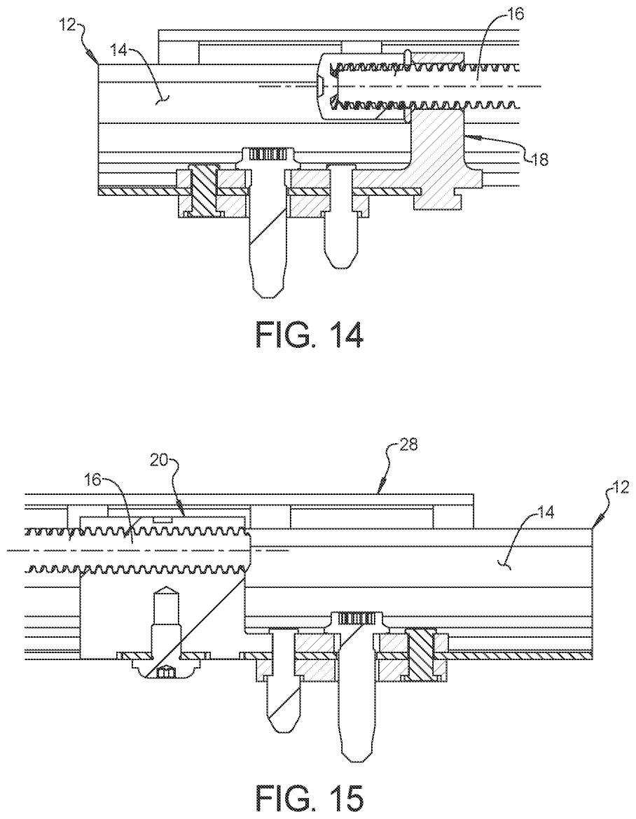

With reference to FIGS. 1-3, a pair of power rails 10 for a seat adjustment system will now be described. The pair of power rails 10 each include an outer track 12 defining an elongated channel 14. An elongated lead screw 16 is mounted in the channel 14 by a front attachment bracket 18 and a rear attachment bracket 20 that are mounted to a base 12a of the outer track 12. A detailed cross-sectional view of the front attachment bracket 18 is shown in FIG. 14 and a detailed cross-sectional view of the rear attachment bracket 20 is shown in FIG. 15. The elongated lead screw 16 can be threadedly engaged with at least one of the brackets 18, 20 (see FIG. 15) to prevent axial movement thereof. An inner track 22 is received in the elongated channel 14 and a power length adjuster gear transmission 24 is mounted to the inner track 22 and is drivingly engaged with the elongated lead screw 16. A pair of chair mounting studs 26 are mounted to the inner track 22. A pair of elongated carpet cover rails 28 are connected on opposite sides of the outer track 12 by a plurality of carpet cover brackets 30, as best shown in FIG. 4. The pair of elongated carpet cover rails 28 can be made from plastic and are disposed at the vehicle floor level to cover the carpet edges disposed along the outer track 12.

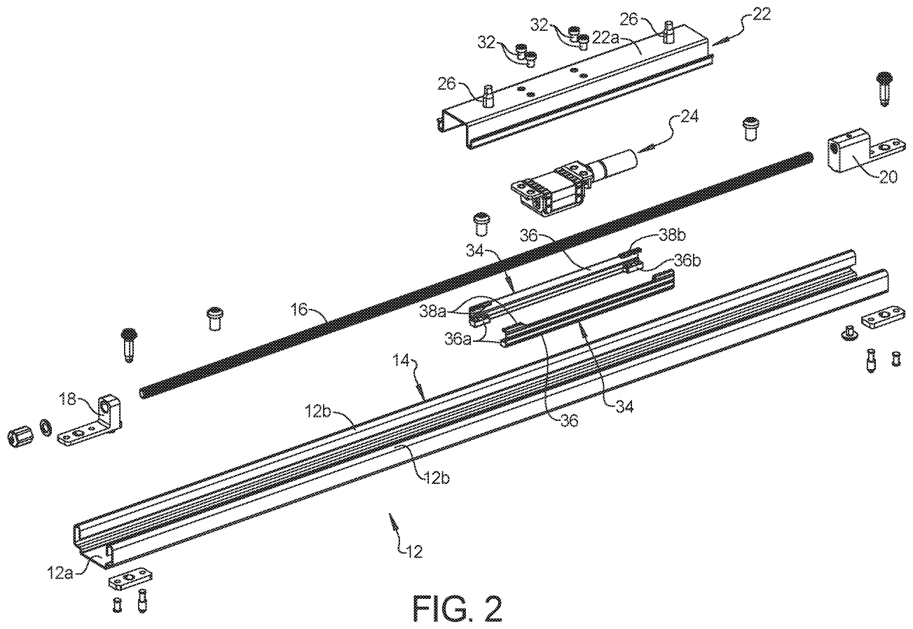

With reference to FIG. 2, the power length adjuster gear transmission 24 is mounted to an upper wall 22a of the inner track 22 by attachment screws 32. The inner track 22 is supported within the channel 14 by a pair of cage roller assemblies 34. The pair of cage roller assemblies 34 include an elongated support 36 that can be made from plastic and that supports a front and a rear cage roller assembly 36a, 36b at opposite ends. The cage roller assemblies 36a, 36b each include one or more roller bearings and can also be made from plastic. The pair of cage roller assemblies 34 can each include a front and a rear clip 38a, 38b that support the pair of cage roller assemblies 34 to the side flanges 22b of the inner track 22 (See FIG. 4). Accordingly, the roller bearing system includes front and rear roller cage pairs 36a, 36b disposed at a front and a rear end of the inner track 22, respectively.

With reference to FIG. 4, the inner track 22 includes the upper wall 22a and the side flanges 22b, each of which is hook-shaped in cross-section. The hook-shaped side flanges 22b bend laterally outward and upward from their bottom end. In addition, the sidewalls 12b of the outer track 12 each include a hook-shaped upper flange in cross-section. The hook-shaped upper flange of the sidewalls 12b bend laterally inward and downward. The pair of side flanges 22b of the inner track 22 are received in the hook-shaped upper flanges of the pair of sidewalls 12b. The base 12a of the outer track 12 includes a pair of stepped side surfaces 12c on which the front and rear cage roller assemblies 36a, 36b are supported. As shown in FIG. 4, a chair structure 39 (a base of which is shown) is mounted to the chair mounting stud 26.

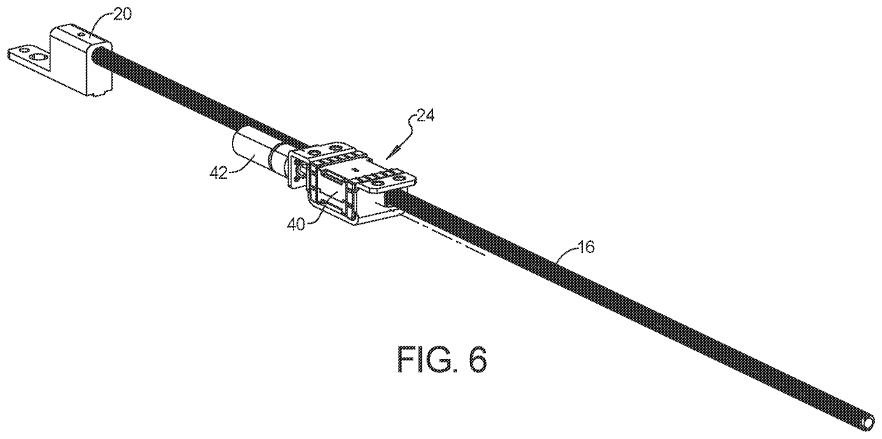

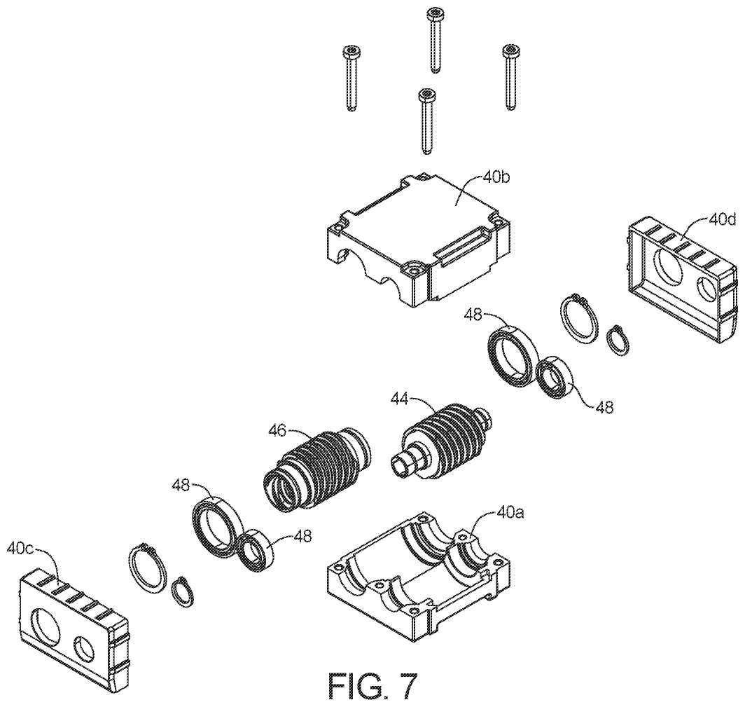

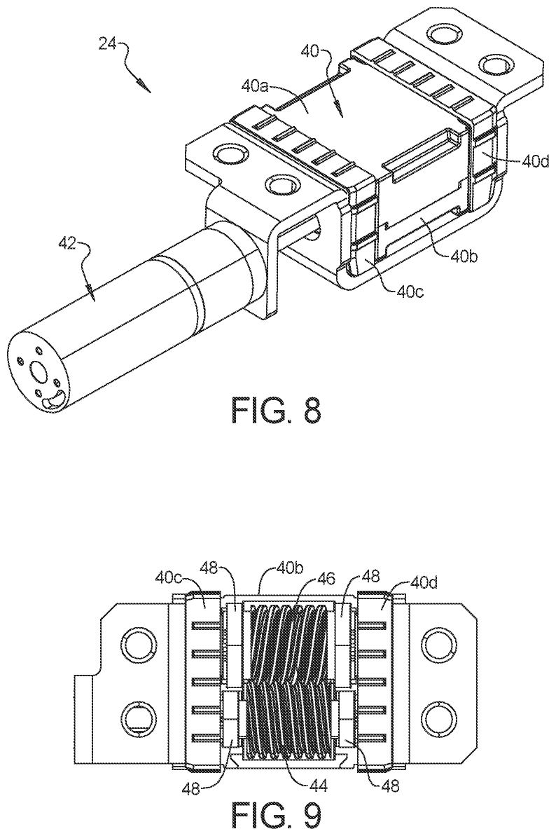

With reference to FIG. 5, the power length adjuster gear transmission 24 is mounted between the pair of side flanges 22b of the inner track 22. With reference to FIGS. 5 and 6, the elongated lead screw 16 extends through a housing 40 of the power length adjuster gear transmission 24. A planetary gear motor 42 is mounted to the housing 40. With reference to FIGS. 7-9, the power length adjuster gear transmission 24 can include an input worm gear 44 connected to the planetary gear motor 42 and an output worm nut 46 threadedly engaged on an interior with the elongated lead screw 16 and drivingly engaged on an exterior with the input worm gear 44. The parallel dual worm gear system 44, 46 is self-locking to prevent movement of the transmission 24 unless driven by the planetary gear motor 42. The planetary gear motor 42 can include a brushless DC motor that drives an optional planetary gear system that is drivingly connected to the input worm gear 44. The housing 40 rotatably supports the input worm gear 44 and the output worm nut 46 via ball bearing assemblies 48. The housing 40 can include upper and lower covers 40a, 40b and end covers 40c, 40d, as best shown in FIG. 7. The end covers 40c, 40d can be made from plastic.

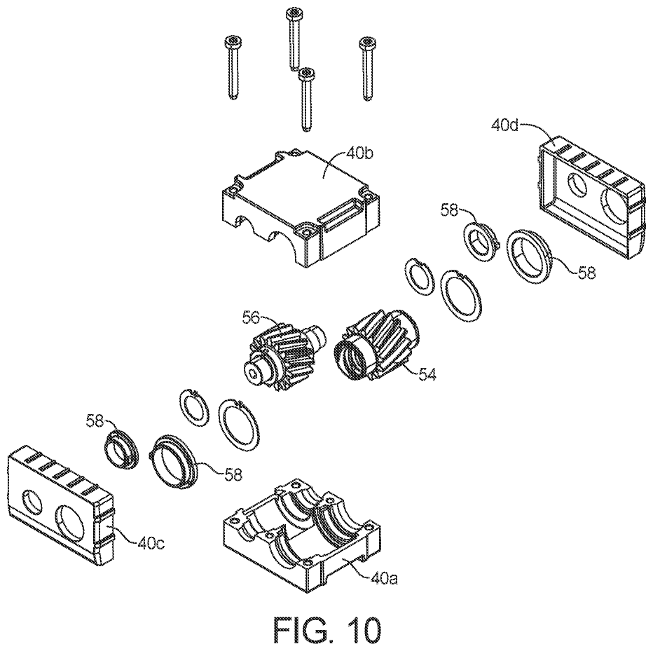

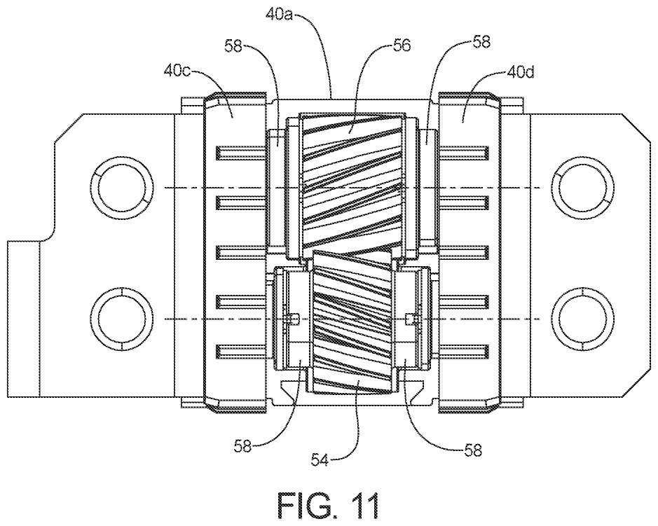

According to an alternative embodiment as shown in FIGS. 10-11, the power length adjuster gear transmission 24 can include an input helical gear 54 connected to the planetary gear motor 42 and a helical gear nut 56 threadedly engaged on an interior with the elongated lead screw 16 and drivingly engaged on an exterior with the input helical gear 54. The planetary gear motor 42 can include a brushless DC motor that drives an optional planetary gear system that is drivingly connected to the input helical gear 54. The housing 40 rotatably supports the input helical gear 54 and the output helical gear nut 56 via ball bearing bushings 58 that can be made from plastic.

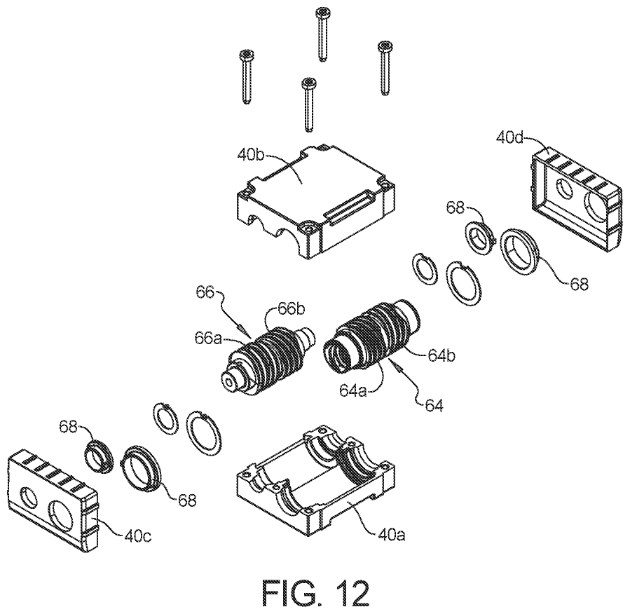

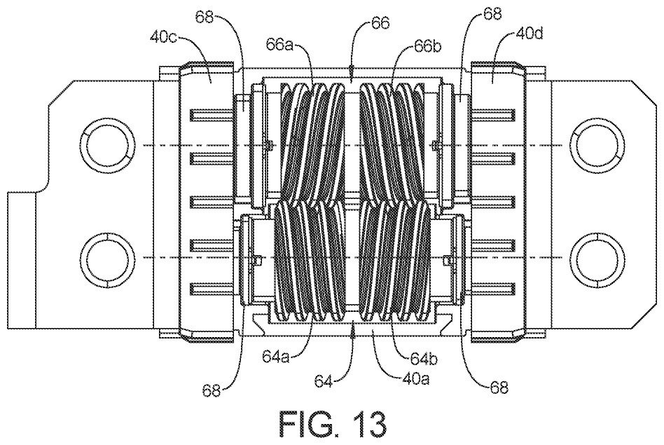

According to an alternative embodiment as shown in FIGS. 12-13, the power length adjuster gear transmission 24 can include a herringbone input worm 64 connected to the planetary gear motor 42 and a herringbone output worm nut 66 threadedly engaged on an interior with the elongated lead screw 16 and drivingly engaged on an exterior with the herringbone input worm 64. The herringbone input worm 64 and the herringbone output worm nut 66 each have a first worm thread 64a, 66a and a second opposite direction worm thread 64b, 66b that balance the axial loads of one another to provide an axial load free gear system. The parallel herringbone type dual worm gear system 64, 66 is also self-locking to prevent movement of the transmission 24 unless driven by the planetary gear motor 42. In addition, the planetary gear motor 42 can include a brushless DC motor that drives an optional planetary gear system that is drivingly connected to the input herringbone worm 64. The housing 40 rotatably supports the input herringbone worm 64 and the output herringbone worm nut 66 via ball bearing bushings 68 that can be made from plastic.

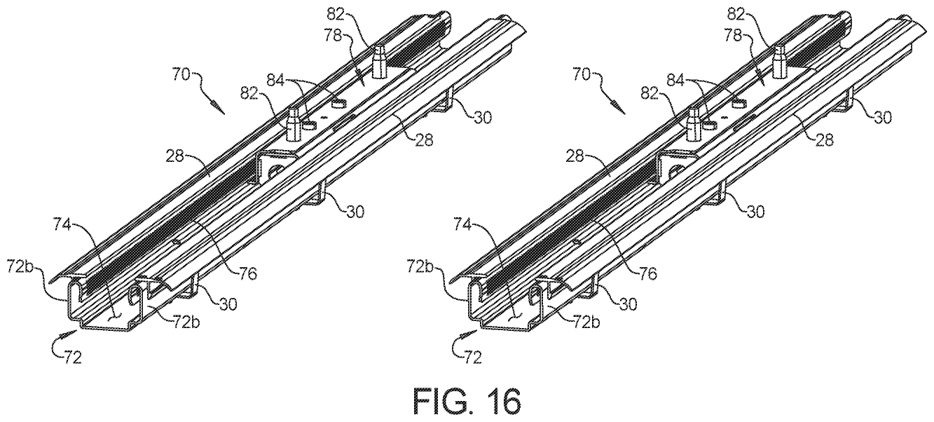

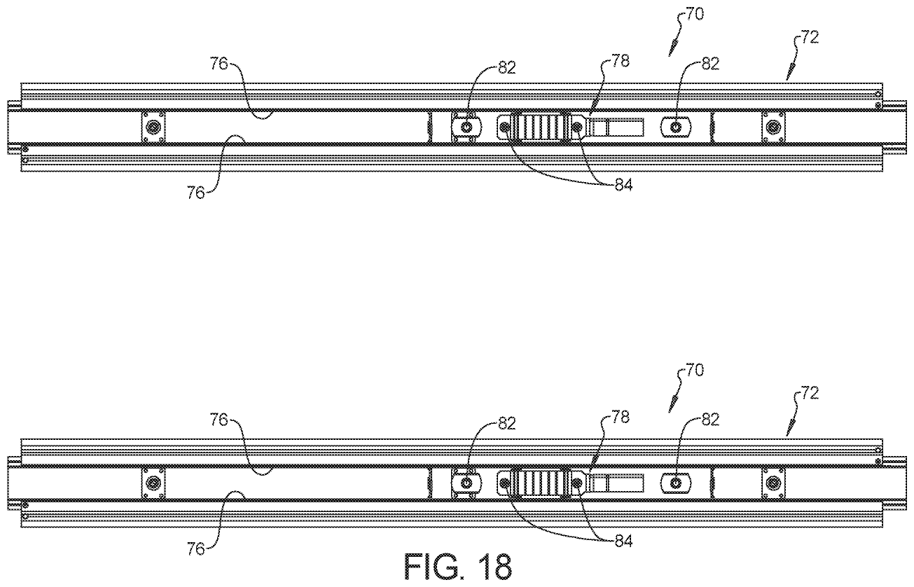

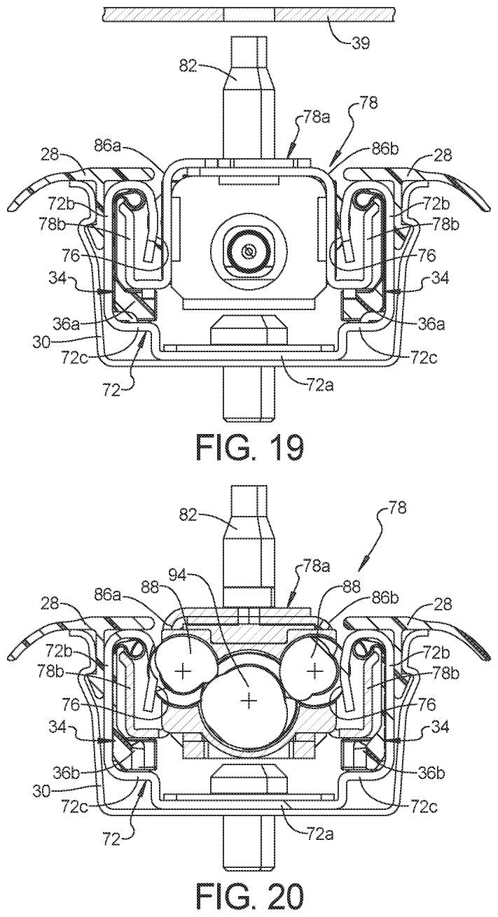

With reference to FIGS. 16-18, a pair of power rails 70 for a seat adjustment system will now be described. The pair of power rails 70 each include an outer track 72 defining an elongated channel 74. A pair of screw thread racks 76 extend along each of the side walls 72b on opposite sides of the channel 74. The screw thread racks 76 are integrally formed within the side walls 72b by spaced diagonal grooves 76a formed into the sidewalls 72b by cutting or stamping. The outer track 72 can be formed from an elongated sheet of steel or other appropriate metal. The two laterally spaced rows of diagonal grooves 76a can be cut or stamped from the sheet and the sheet can be bent from a flat configuration into the cross-section shown in FIGS. 19 and 20.

An inner track 78 is received in the elongated channel 74 of the outer track 72 and a power length adjuster gear transmission 80 is mounted to the inner track 78 and is drivingly engaged with the pair of screw thread racks 76. A pair of chair mounting studs 82 are mounted to the inner track 78. A pair of elongated carpet cover rails 28 are connected on opposite sides of the outer track 72 by a plurality of carpet cover brackets 30, as best shown in FIGS. 19 and 20. In a vehicle assembly, the pair of elongated carpet cover rails 28 are disposed at the vehicle floor level to cover the carpet edges disposed along the outer track 72.

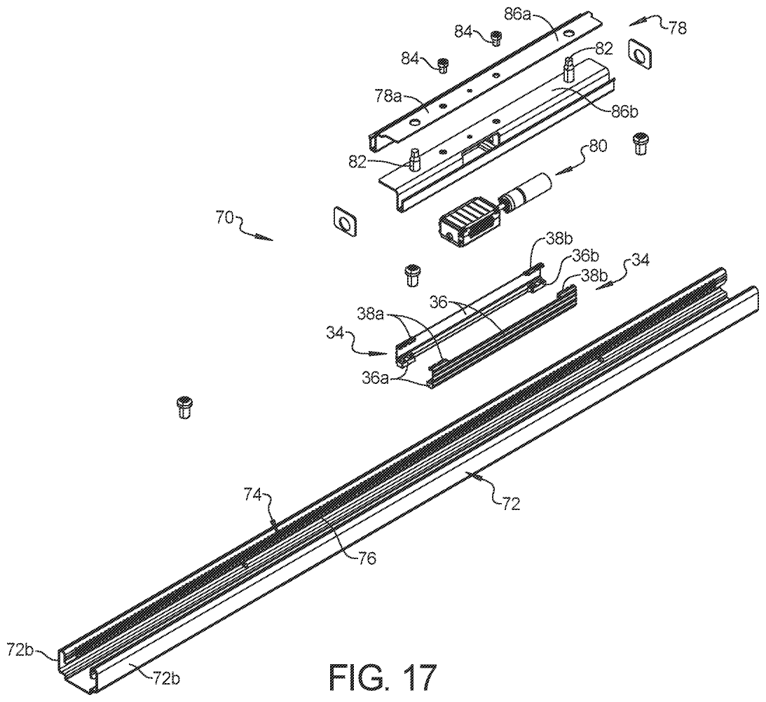

With reference to FIG. 17, the power length adjuster gear transmission 80 is mounted to an upper wall 78a of the inner track 78 by attachment screws 84. The inner track 78 is supported within the channel 74 by a pair of cage roller assemblies 34. The pair of cage roller assemblies 34 include an elongated support 36 that supports a front and a rear cage roller assembly 36a, 36b at opposite ends. The cage roller assemblies 36a, 36b each include one or more roller bearings. The pair of cage roller assemblies 34 can each include a front and a rear clip 38a, 38b that support the pair of cage roller assemblies 34 to the side flanges 78b of the inner track 78 (See FIG. 19). Accordingly, the roller bearing system includes front and rear roller cage pairs 36a, 36b disposed at a front and a rear portion of the inner track 78, respectively.

With reference to FIG. 19, the inner track 78 can be formed by two plates 86a, 86b that are assembled together to include the upper wall 78a and the pair of side flanges 78b, each of which is hook-shaped in cross-section. The hook-shaped side flanges 78b bend outward and upward. In addition, the sidewalls 72b of the outer track 72 each include a hook-shaped upper flange in cross-section. The hook-shaped upper flange of the sidewalls 72b bend inward and downward with the diagonal grooves 76b of the screw thread racks 76 being formed directly in and along the sidewalls 72b. The pair of side flanges 78b of the inner track 78 are received in the hook-shaped upper flanges of the pair of sidewalls 72b. The base 72a of the outer track 72 includes a pair of stepped side surfaces 72c on which the front and rear cage roller assemblies 36a, 36b are supported. As shown in FIG. 19, a chair structure 39 (a base of which is shown) is mounted to the chair mounting stud 82.

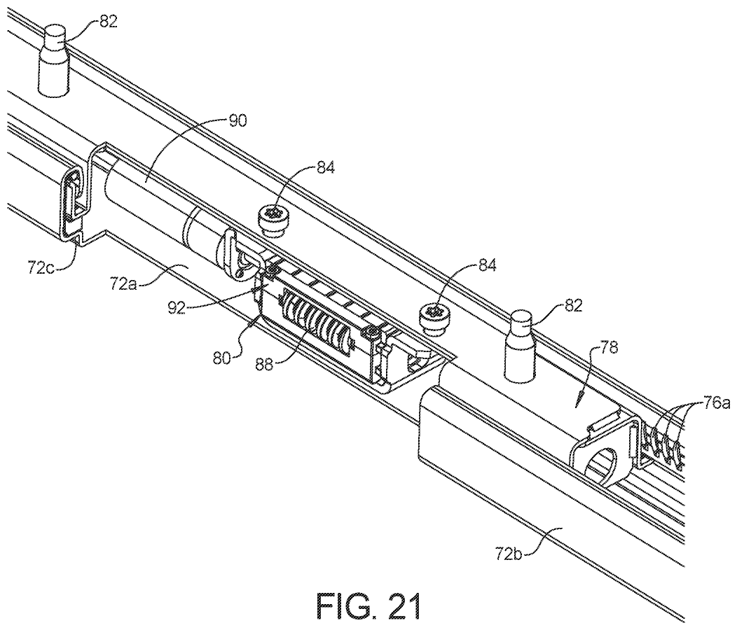

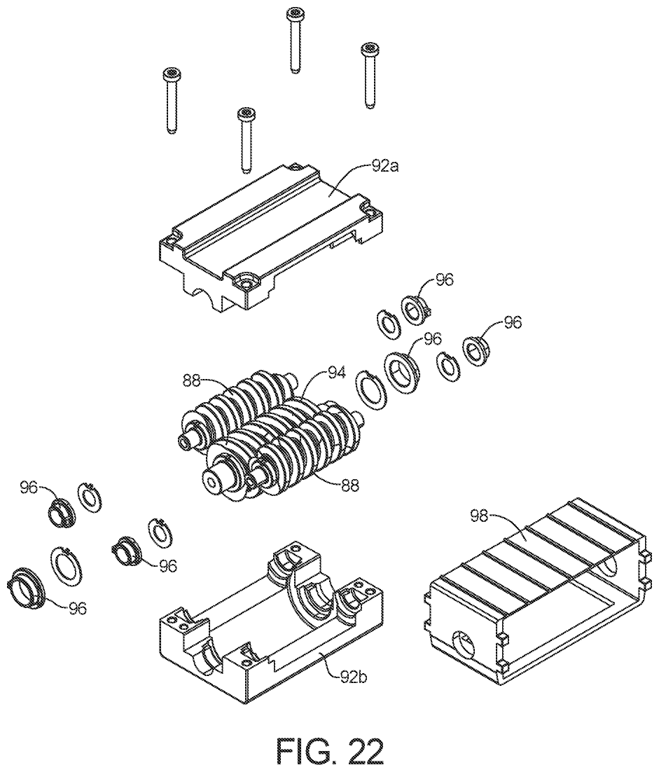

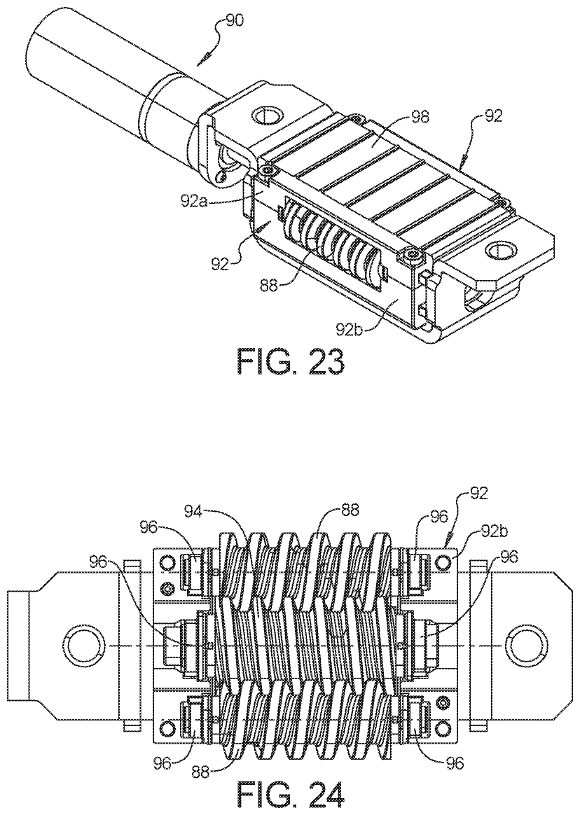

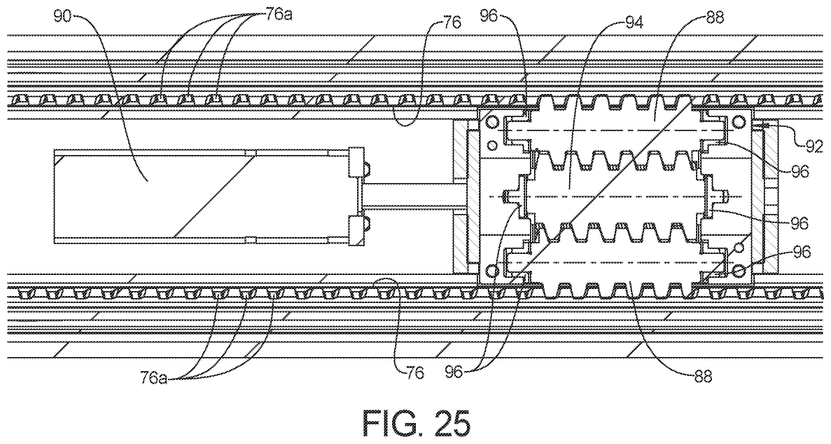

With reference to FIG. 20, the power length adjuster gear transmission 80 is mounted between the pair of side flanges 78b of the inner track 78. With reference to FIGS. 20 and 21, the power length adjuster gear transmission 80 rotatably supports a pair of twin drive worms 88 that are each drivingly engaged with a respective one of the pair of screw thread racks 76, as best shown in FIG. 25. With reference to FIGS. 21 and 23, a planetary gear motor 90 is mounted to a housing 92. With reference to FIGS. 22-24, the power length adjuster gear transmission 80 can include an input worm gear 94 connected to the planetary gear motor 90 and the pair of twin drive worm 88 are engaged with the input worm gear 94. The twin drive worm system 88 is self-locking to prevent movement of the transmission 80 unless driven by the planetary gear motor 90. The planetary gear motor 90 can include a brushless DC motor that drives an optional planetary gear system that is drivingly connected to the input worm gear 94. The housing 92 rotatably supports the input worm gear 94 and the pair of twin drive worms 88 via bearing assemblies 96 that can be made from plastic. The housing 92 can include upper and lower covers 92a, 92b that are bolted together and a rubber gearbox bearing 98, as best shown in FIG. 22.

With the power long rail system of the present disclosure, a smooth and quiet seat adjustment is provided with a very low, hidden profile and neatly compartmentalized moving parts completely integrated inside the outer tracks with maximized range of motion therein. The power tracks are completely mounted under the vehicle floor.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power rail system for a vehicle seat, comprising:
an outer track defining an elongated channel;
an elongated lead screw mounted in the channel;
an inner track received in the elongated channel; and
a power length adjuster gear transmission mounted to the inner track and drivingly engaged with the elongated lead screw.

2. The power rail system according to claim 1, wherein the inner track is supported within the channel by a roller bearing system.

3. The power rail system according to claim 2, wherein the roller bearing system includes front and rear roller cage pairs disposed at a front and a rear end of the inner track, respectively.

4. The power rail system according to claim 3, wherein the inner track includes a pair of side flanges and the front and rear roller cage pairs are supported by the side flange of the inner track.

5. The power rail system according to claim 1, wherein the outer track includes a base and a pair of sidewalls, the pair of sidewalls each include a hook-shaped upper flange in cross-section.

6. The power rail system according to claim 5, wherein the inner track includes a pair of side flanges that are received in the hook-shaped upper flanges of the pair of sidewalls.

7. The power rail system according to claim 1, further comprising a pair of elongated carpet cover rails connected on opposite sides of the outer track.

8. The power rail system according to claim 1, wherein the inner track includes an upper wall and a pair of sidewalls and the power length adjuster gear transmission is mounted between the pair of sidewalls of the inner track.

9. The power rail system according to claim 1, wherein the power length adjuster gear transmission includes an input worm gear connected to a drive motor and an output worm nut disposed on the elongated lead screw and drivingly engaged with the input worm gear.

10. The power rail system according to claim 1, wherein the power length adjuster gear transmission includes an input helical gear connected to a drive motor and an output helical gear nut disposed on the elongated lead screw and drivingly engaged with the input helical gear.

11. The power rail system according to claim 1, wherein the power length adjuster gear transmission includes a herringbone input worm gear connected to a drive motor and an output herringbone worm nut disposed on the elongated lead screw and drivingly engaged with the herringbone input worm gear.

12. The power rail system according to claim 1, wherein the elongated lead screw is mounted to a front attachment bracket and a rear attachment bracket each mounted to a base of the outer track.

13. A vehicle seat, comprising:
a pair of power rails each including:
an outer track defining an elongated channel;
an elongated lead screw mounted in the channel;
an inner track received in the elongated channel; and
a power length adjuster gear transmission mounted to the inner track and drivingly engaged with the elongated lead screw; and
a seat structure mounted to the inner track of each of the pair of power rails.

14. A power rail system for a vehicle seat, comprising:
an outer track defining an elongated channel with a pair of sidewalls each including an integrally formed screw thread rack;
an inner track received in the elongated channel; and
a power length adjuster gear transmission mounted to the inner track and drivingly engaged with the screw thread racks on each of the pair of sidewalls.

15. The power rail system according to claim 14, wherein the inner track is supported within the channel by a roller bearing system.

16. The power rail system according to claim 15, wherein the roller bearing system includes front and rear roller cage pairs disposed at a front and a rear end of the inner track, respectively.

17. The power rail system according to claim 14, wherein the outer track includes a base disposed between the pair of sidewalls, the pair of sidewalls each include a hook-shaped upper flange in cross-section.

18. The power rail system according to claim 14, further comprising a pair of elongated carpet cover rails connected on opposite sides of the track.

19. The power rail system according to claim 14, wherein the inner track includes an upper wall and a pair of sidewalls and the power length adjuster gear transmission is mounted between the pair of sidewalls of the inner track.

20. The power rail system according to claim 14, wherein the power length adjuster gear transmission includes an input worm gear connected to a drive motor and a pair of twin drive worms drivingly engaged with the input worm gear and a respective one of the screw thread racks of the pair of sidewalls of the outer track.
